(19) United States
(12) Patent Application Publication
(10) Pub. No.: US 2025/0081065 A1
(43) Pub. Date: Mar. 6, 2025

(54) CONTROL METHOD FOR AUTOMATICALLY ESTABLISHING OR AUTOMATICALLY SWITCHING VEHICLE COMMUNICATION FOR DATA EXCHANGE BETWEEN A VEHICLE AND A REMOTE STATION

(71) Applicant: MERCEDES-BENZ GROUP AG, Stuttgart (DE)

(72) Inventor: Osman AYDIN, Leinfelden-Echterdingen (DE)

(73) Assignee: MERCEDES-BENZ GROUP AG, Stuttgart (DE)

(21) Appl. No.: 18/272,671

(22) PCT Filed: Dec. 8, 2021
(86) PCT No.: PCT/EP2021/084692

§ 371 Date: Jul. 17, 2023

(30) Foreign Application Priority Data
Jan. 19, 2021 (DE) 10 2021 000 246.6

(51) Int. Cl. H04W 36/22; H04W 28/02; H04W 36/30; H04W 76/15

(52) U.S. Cl. CPC H04W 36/22; H04W 28/0215; H04W 28/0236; H04W 28/0268; H04W 36/30; H04W 76/15

(57) ABSTRACT

A method for automatically establishing or automatically switching vehicle communication for data exchange between a vehicle and a remote station involves the vehicle being driven with various levels of autonomy. The data is transmitted between the vehicle and the remote station via at least one of the following types of network connection: a network connection in a terrestrial network, a network connection in a non-terrestrial network; and parallel network connections in a terrestrial and a non-terrestrial network. The type of network connection is selected based on a currently set and/or requested level of autonomy.

### BACKGROUND AND SUMMARY OF THE INVENTION

Exemplary embodiments of the present invention relate to a control method for automatically establishing or automatically switching vehicle communication for data exchange between a vehicle and a remote station.

From the field of data transmission in mobile networks, it is known to adjust the quality and speed of data transmission based on user requirements. For example, a user can be guaranteed a certain transmission quality and/or transmission speed by a provider, secured by an individual contract design, whereby these can be defined, for example, by specifying quality of service (QOS) requirements. Such a quality of service describes the quality of a communication service from the point of view of the respective user and contains various quality requirements for data transmission.

It is also generally known that the selection of an appropriate network connection is a function of the quality of service requirements.

Nowadays, terrestrial networks, in particular mobile networks, and non-terrestrial networks, in particular satellite-based communication, are available for wireless data transmission on a larger scale. WO 98/10521 A2 discloses a mobile terminal that automatically switches between a satellite-based network and a terrestrial network. Switching can be performed depending on a data protocol selected by a user or automatically.

Furthermore, in order to be able to ensure particularly high data transmission rates for certain users in the mobile network, so-called network slicing has been proposed, see “5G Service-Guaranteed Network Slicing White Paper,” version 1.0, issued on Feb. 28, 2017 (China Mobile Communications Corporation, Huawei Technologies Co., Ltd., Deutsche Telekom AG, Volkswagen).

Thus, to be sure, network connections are available for mobile data transmission in networks that guarantee the highest data transmission quality and transmission speeds. However, the use of such network connections and the reservation of corresponding connection capacities is associated with comparatively high costs. In addition, there is a threat of congestion of such high-speed network links with the progressive introduction of “Internet of Things” technologies, for example, m2m (machine-to-machine) services or the development of autonomous driving of motor vehicles. Particularly in the case of autonomously or semi-autonomously driving motor vehicles, a large amount of data is transmitted between a vehicle and a remote station in order to control the vehicles, as is the case with the present invention, wherein the remote station can be one or more further vehicles, parts of a traffic infrastructure, or manually operable terminals. If all such data is transmitted over the available networks with the highest data quality and data transmission rate, this is associated with high costs and a correspondingly high utilization of such networks.

US 2019/0258251 A1 discloses a system that improves the functionality of vehicles driving autonomously in levels of autonomy 3 to 5, wherein super-learning supercomputers in a platform communicating with the vehicles are used to improve the learning outcomes of the individual vehicles. Data transmission takes place between the vehicle and a remote station, specifically a cloud-based infrastructure that includes supercomputers. The data from each vehicle in levels of autonomy 3 to 5 is to be transmitted to the cloud-based infrastructure via a mobile radio network or other terrestrial network, such as LTE where available, WCDMA, UMTS, CDMA2000, HSPA+, GSM, or a satellite network. The cloud-based infrastructure analyzes such data and then transmits an update to self-driving vehicles.

U.S. Pat. No. 9,565,625 B1 discloses a selection of best available network connections when a vehicle is moving along a route. A network coverage map is generated, which the vehicle can use to determine which network is available at which location and with which signal strength. This allows the vehicle to select one or more types of network connections in various areas along a path to optimize communications.

US 2017/0219364 A1 discloses semi-autonomous or fully autonomous vehicles, wherein a navigation system takes into account, in addition to conventional parameters, on which portion of a route the vehicle can drive autonomously. This allows the driver to preferentially select routes on which the vehicle drives largely autonomously.

WO 2020/107991 A1 discloses a method, a device and a system for autonomous vehicles.

Exemplary embodiments of the present invention are directed to a control method for automatically establishing or automatically switching vehicle communication for data exchange between a vehicle and a remote station, with which the costs and network utilization of particularly technology- and cost-intensive networks can be reduced.

According to the invention, all data is no longer transmitted with the best available network connection; rather, a specific selection of an available network connection is carried out based on the level of autonomy with which the vehicle is currently being driven or with which the vehicle is to be driven. This makes it possible, for example, to avoid unnecessary parallel network connections (multi-connectivity connections) in various networks that would otherwise increase the operating costs and network load of such networks. This means that network resources are used more efficiently than before.

In detail, according to the control method according to the invention for automatically establishing a new vehicle communication or for automatically switching an existing vehicle communication for data exchange between a vehicle and a remote station, wherein the vehicle is driven with various levels of autonomy, the data is transmitted between the vehicle and the remote station via at least one of the following types of network connection: specifically a network connection in a terrestrial network, a network connection in a non-terrestrial network, and parallel network connections in a terrestrial and non-terrestrial network, wherein the type of network connection is selected based on a currently set and/or requested level of autonomy.

The definition of the levels of autonomy can be made in accordance with SAE J3016, in the version applicable on the priority date of the present application. In particular, a definition of five levels of autonomy is provided, wherein no automation is provided in level 0, meaning that all aspects of the dynamic driving task are performed on a continuous basis by the human driver, even if supportive warning or intervention systems are used, and full automation is provided in level 5, with a continuous performance of all aspects of the dynamic driving task by an automated driving system under all driving and environmental conditions that could be handled by a human driver. In Level 1, the driver is assisted in certain driving situations by driver assistance systems that intervene in an accelerating, decelerating, or steering manner with information about the driving environment and with the expectation that the human driver will take over all remaining dynamic driving tasks. In Level 2, the driver is assisted in certain driving situations by one or more driver assistance systems that intervene in both an accelerating/decelerating and in a steering manner with information about the driving environment and with the expectation that the human driver will take over all remaining dynamic driving tasks. In Level 3, dependent automation occurs with all aspects of the dynamic driving task, except that the human driver takes control of the vehicle when requested to intervene. Level 4 describes highly automated driving with all aspects of the dynamic driving task, even if the human driver does not intervene as requested and take control of the vehicle.

In particular, the fastest and/or highest-quality type of network connection can be selected when the level of autonomy is set and/or requested at a comparatively high level, for example at level 3, 4 or 5 according to one exemplary embodiment, only at level 4 or 5 according to another exemplary embodiment or according to another exemplary embodiment can only be selected at level 5. If available, the simultaneous use of at least one terrestrial and one non-terrestrial network is particularly selected for this purpose, by establishing the specified parallel network connections.

According to the invention, the best and most efficient network connection can be selected, because the network connections in the terrestrial network and the network connections in the non-terrestrial network are independent of one another. This makes it possible to provide sufficient network connectivity in geographically extremely large areas.

If parallel network links are used in a terrestrial and non-terrestrial network, the establishment of a link can be realized, in particular, according to EN-DC (E-UTRA-NR dual connectivity), SUL (supplement uplink) or SDL (supplement downlink) or even as carrier aggregation (CA) as described in ETSI or 3GPP telecommunication standards as applicable on the priority date of the present application.

Particularly preferably, the type of network connection is additionally selected based on software applications and/or hardware applications activated and/or requested in the vehicle, each of which has one of a plurality of quality of service (QOS) requirements. For example, the type of network connection can be selected based on an app activated in the vehicle user interface and/or an app activated on a smartphone connected to the vehicle user interface, or based on settings in the app.

Quality of service requirements may differ by, for example, latency, jitter, data error rate, packet loss rate and/or data throughput. In particular, the quality of service requirements may differ by various Rx levels, Tx levels, and/or by various RxQual values.

According to a particularly advantageous embodiment of the invention, the type of network connection is selected based on the currently achieved signal propagation time and/or a predetermined signal propagation time.

Particularly preferably, network connections with various signal propagation times and/or various data throughput rates can be selected within the terrestrial network and/or within the non-terrestrial network, and one of such network connections within the corresponding network is selected based on the set and/or requested level of autonomy and/or on the basis of the software applications and/or hardware applications activated and/or requested in the vehicle. This enables even better optimization of network connection selection and extremely efficient use of the available networks.

Data transmission in the non-terrestrial network is carried out, in particular, via satellites.

Data transmission in the terrestrial network is carried out, for example, via one or more mobile radio networks, in particular with various mobile radio standards.

Particularly preferably, individual satellites and/or satellite groups on various earth orbits can be selected for data transmission, and the selection of such satellites and/or satellite groups is carried out based on the set and/or requested level of autonomy and/or based on the software applications and/or hardware applications activated and/or requested in the vehicle. For example, at a comparatively higher level of autonomy, a satellite comparatively near to earth and/or a satellite group comparatively near to earth can then be selected, in particular a satellite or a satellite group on a comparatively near-earth orbit.

Accordingly, when the level of autonomy is comparatively higher and the network connection is in a terrestrial network, a mobile radio standard with a comparatively higher data transmission rate can be selected if various high data transmission rates are selectably available in various mobile radio standards.

In the case of terrestrial networks, WLAN-based network connections can be selected preferentially in addition to or as an alternative to mobile radio networks. Here as well, the selection of connections shown can be carried out with a higher data transmission rate at a comparatively higher level of autonomy.

For non-terrestrial networks, drone-based networks can be used in addition to or as an alternative to satellite-based networks with corresponding network connections and the selection of the corresponding network connection as shown.

Quality of service requirements that may be used to select the type of network connection within the scope of the present invention are disclosed, for example, in 3GPP TS 22.885 and TS 22.186, each as in effect on the priority date of the present application.

The invention will be described below by means of an exemplary embodiment and the figures.

### BRIEF DESCRIPTION OF THE DRAWING FIGURES

In the drawings:

FIG. 1 is the schematic illustration of automatically establishing or switching vehicle communication from a terrestrial network to a non-terrestrial network according to the invention;

FIG. 2 shows an automatic establishing or switching of a vehicle communication according to the present invention from a non-terrestrial network to a terrestrial network;

FIG. 3 shows a corresponding switching from a terrestrial network to parallel network connections in a terrestrial and non-terrestrial network; and

FIG. 4 shows a corresponding switching from a non-terrestrial network to parallel network connections in a terrestrial and a non-terrestrial network.

### DETAILED DESCRIPTION

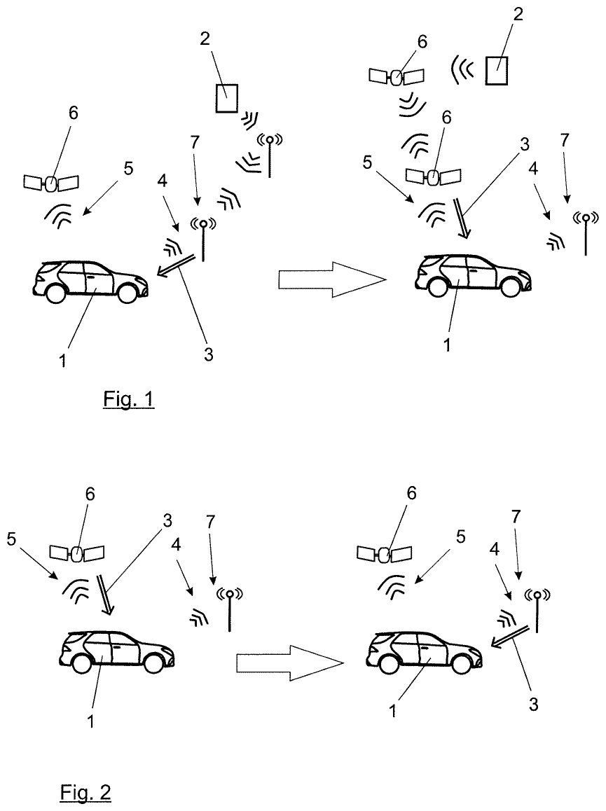

FIG. 1 schematically shows a vehicle 1 that is connected to a remote station 2 via a network connection 3 and exchanges data with the remote station 2 via such network connection 3. Thereby, the vehicle 1 is autonomously controlled, for example, at a comparatively low level of autonomy, for which the data exchange takes place. The network connection 3 is established via a terrestrial network 4. The terrestrial network 4 comprises, for example, one or more selectable mobile networks 7 with corresponding transmission towers.

If the level of autonomy is now increased, a qualitatively higher and/or faster available network connection 3 is to be used. In the exemplary embodiment shown in FIG. 1, such better network connection 3 can be established via a non-terrestrial network 5, which establishes the network connection 3 via satellites 6. Accordingly, when the comparatively higher level of autonomy is requested or set, the network connection 3 is switched to the non-terrestrial network 5.

In the situation shown schematically in FIG. 2, it is determined, for example, that a network connection 3 in a terrestrial network 4 is better than the set network connection 3 in the non-terrestrial network 5, wherein the comparatively high level of autonomy is still set. Therefore, a switching of the network connection 3 to the terrestrial network 4 takes place.

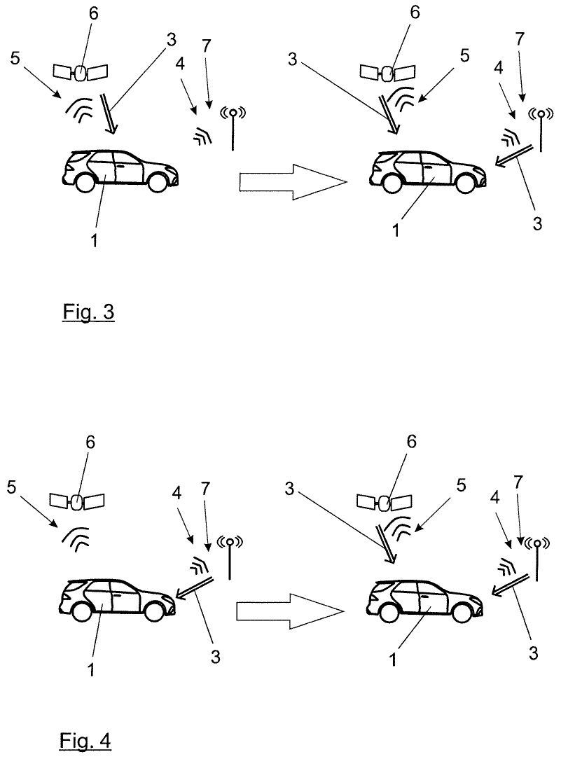

According to FIG. 3, either an even higher level of autonomy is to now be set or the existing network connection 3 via the terrestrial network 4 is not fully sufficient for data exchange and the sole use of a network connection 3 in a non-terrestrial network 5 is also insufficient. Therefore, switching to parallel network connections 3 in a terrestrial and a non-terrestrial network 4, 5 takes place.

The situation according to FIG. 4 corresponds to that of FIG. 3, except that initially there was only one network connection 3 in a non-terrestrial network 5.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for automatically establishing or automatically switching vehicle communication for data exchange between a vehicle and a remote station, the method comprising:
determining a currently set or requested level of autonomous control for the vehicle; and
selecting a type of network connection based on the currently set or requested level of autonomous control for the vehicle,
wherein the selected network connection is used to transmit data between the vehicle and the remote station via at least one of the following types of network connection
a network connection in a terrestrial network,
a network connection in a non-terrestrial network, and
parallel network connections in the terrestrial and the non-terrestrial network.

12. The method of claim 11, wherein the type of network connection is further selected based on software applications or hardware applications activated or requested in the vehicle, each of which has one of a plurality of quality of service requirements.

13. The method of claim 12, wherein the plurality of quality of service requirements differ by latency, jitter, data error rate, packet loss rate, or throughput.

14. The method of claim 11, wherein the type of network connection is further selected based on a currently achieved signal propagation time or a predetermined signal propagation time.

15. The method of claim 12, wherein
network connections with various signal propagation times or data throughput rates are selectable within the terrestrial network or network connections with various signal propagation times or data throughput rates are selectable within the non-terrestrial network, and
one of the network connections is selected based on the set or requested level of autonomy or based on the software application or hardware application activated or requested in the vehicle.

16. The method of claim 11, wherein data transmission in the non-terrestrial network is performed via satellites.

17. The method of claim 16, wherein individual satellites or satellite groups on various earth orbits are selectable for data transmission and the selection of the satellites or satellite groups is performed based on the set or requested level of autonomy or based on the software application or hardware application activated or requested in the vehicle.

18. The method of claim 17, wherein at a comparatively higher level of autonomy, a satellite comparatively near to earth or a satellite group comparatively near to the earth is selected.

19. The method of claim 15, wherein the data transmission in the terrestrial network occurs via one or more mobile radio networks with various mobile radio standards.

20. The method of claim 19, wherein at a comparatively higher level of autonomy, a mobile communications standard with a comparatively higher data transmission rate is selected.
